(19) United States
(12) Patent Application Publication
(10) Pub. No.: US 2024/0237020 A9
(43) Pub. Date: Jul. 11, 2024

(54) EARLY TERMINATION METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Qin MU, Beijing (CN)

(73) Assignee: BEIJING XIAOMI MOBILE SOFTWARE CO., LTD., Beijing (CN)

(21) Appl. No.: 18/275,780

(22) PCT Filed: Feb. 5, 2021
(86) PCT No.: PCT/CN2021/075578

§ 371 Date: Aug. 3, 2023

(51) Int. Cl. H04W 72/232; H04L 1/1812; H04W 72/044; H04W 72/51

(52) U.S. Cl. CPC H04W 72/232; H04L 1/1812; H04W 72/0473; H04W 72/51

(57) ABSTRACT

The present disclosure provides an early termination method and apparatus, a communication device, and a storage medium. The method includes: instructing a terminal to terminate a repeated transmission by means of an information domain in downlink control information (DCI).

### CROSS-REFERENCE TO RELATED APPLICATION

The present application is a U.S. National Stage of International Application No. PCT/CN2021/075578, filed on Feb. 5, 2021, the contents of which are incorporated herein by reference in their entireties for all purposes.

### BACKGROUND

In LTE 4G systems, two major technologies, Machine Type Communication (MTC) and Narrow band Internet of things (NB-IoT), have been proposed to support IoT services. These two major technologies are mainly aimed at low-speed and high-latency scenarios, such as meter reading scenarios, and environmental monitoring scenarios.

### SUMMARY

The present disclosure relates to the field of mobile communication technologies, and more particularly, to an early termination method and apparatus, a communication device and a storage medium.

In a first aspect, embodiments of the present disclosure propose an early termination method, which is applied to a network, and the early termination method includes: instructing, through an information domain in Downlink Control Information (DCI), a first type of terminal to terminate a repeated transmission.

In a second aspect, embodiments of the present disclosure propose an early termination method, which is applied to a first type of terminal, and the early termination method includes: monitoring a Physical Downlink Control Channel (PDCCH) carrying Downlink Control Information (DCI); and terminating a repeated transmission of the first type of terminal according to indication information of a DCI information domain.

In a third aspect, embodiments of the present disclosure propose a communication device, including a processor, a transceiver, a memory, and a computer program stored on the memory, wherein the processor implements the early termination method proposed in embodiments of the first aspect or the second aspect by running the computer program.

Additional aspects and advantages of the present disclosure will be set forth in part in the following description, and in part will be obvious from the following description, or may be learned by practice of the present disclosure.

### BRIEF DESCRIPTION OF THE DRAWINGS

The above and/or additional aspects and advantages of the present disclosure will become apparent and easy to understand from the following description of embodiments in conjunction with the accompanying drawings, in which:

FIG. 1 is a schematic flowchart of an early termination method according to an embodiment of the present disclosure;

FIG. 2 is a code stream schematic diagram of DCI according to an embodiment of the present disclosure;

FIG. 3 is a schematic flowchart of an early termination method according to another embodiment of the present disclosure;

FIG. 4 is a schematic structural diagram of an early termination apparatus according to an embodiment of the present disclosure;

FIG. 5 is a schematic structural diagram of an early termination apparatus according to another embodiment of the present disclosure; and

FIG. 6 is a structural block diagram of a communication device according to an embodiment of the present disclosure.

### DETAILED DESCRIPTION

Embodiments of the present disclosure are described in detail below, examples of which are illustrated in the accompanying drawings, and the same or similar reference numerals denote the same or similar elements or elements having the same or similar functions throughout the drawings. The embodiments described below with reference to the accompanying drawings are illustrative, are intended to explain the present disclosure, and should not be construed as limiting the present disclosure.

In the related art, a network speed is improved by enhancing coverage. For Redcap terminals that need coverage enhancement, a network may configure excessive repeated transmission times for the terminals due to factors such as inaccurate measurement or channel fluctuations. On the network, it is possible that data has been successfully demodulated before the terminal has sent all the repeated transmissions, and in this case, the network may send a reception confirmation indication to the terminal to indicate the terminal to stop the current repeated transmission. Such an operation is conducive to the power saving of the terminal.

In the previous New Radio (NR) unlicensed spectrum of the 5G, early termination is supported, where the confirmation of the early termination is indicated by Downlink control information (DCI) in Downlink Control Information (DCI). However, there is a lack of an indication solution for the early termination for normal terminals with the coverage enhancement.

In embodiments of the present disclosure, an information domain in the DCI is reconstructed, so that the normal NR terminals and the Redcap terminals can support the early termination in a coverage enhancement scenario.

For the convenience of description, the following description will be focused on a network and a first type of terminal side, respectively. The network may include a network device such as a base station, and the first type of terminal may include a terminal with a function of terminating a retransmission, such as a mobile phone, a laptop, and a wearable device.

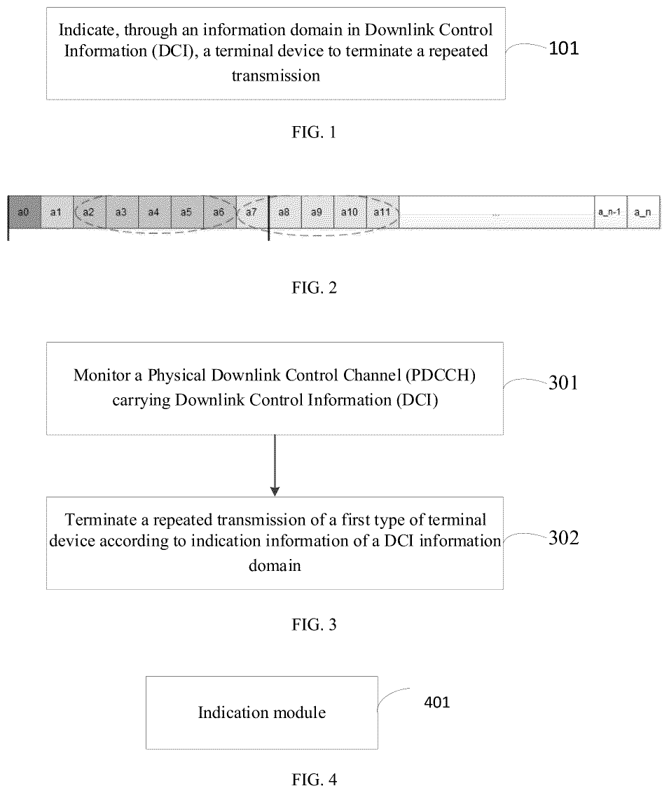

FIG. 1 is a flowchart of a method provided according to an embodiment of the present disclosure. The method is applied to a network such as a base station, and the method includes:

in step 101, a first type of terminal is indicated, through an information domain in Downlink Control Information (DCI), to terminate a repeated transmission.

The DCI may be control information related to a physical uplink and downlink shared channel transmitted by a PDCCH, and the DCI includes several related contents such as RB resource allocation information, a Modulation and Coding Scheme (MCS), a HARQ-ID and so on. Only when the terminal correctly decodes the DCI, it can correctly process Physical Downlink Shared Channel (PDSCH) data or Physical Uplink Shared Channel (PUSCH) data.

In the embodiment, the first type of terminal is indicated, through the information domain in the DCI, to terminate the repeated transmission. Referring to FIG. 2, a DCI code stream is transmitted in a basic unit of bit (a0, a1 . . . in the figure), and the information domain here thus may be one or more bits.

To sum up, according to the early termination method of embodiments of the present disclosure, the network indicates the first type of terminal to terminate the repeated transmission through the information domain in the DCI, thereby realizing that the first type of terminal can support the early termination in the coverage enhancement scenario, so that the first type of terminal can save power in the retransmission scenario.

Based on the above-mentioned embodiments, a manner in which the network indicates the first type of terminal to terminate the repeated transmission through the information domain in the DCI may have different implementations in different scenarios. The following is illustrative description.

### Example 1

In this example, the network indicates the first type of terminal to terminate the repeated transmission through a first information domain in the DCI.

In the embodiment, all or part of bit information of the first information domain may be used to indicate the first type of terminal to terminate the repeated transmission. There may be one or more bits corresponding to the bit information here, and when there is a plurality of bits, the plurality of bits may or may not be consecutive. When there are one or more bits, it may be any one or more bits in the first information domain. That is, in this example, it is indicated, through the information of the one or more bits in the first information domain, that the first type of terminal is prohibited from the repeated transmission.

In the embodiment, part of states represented by all or part of the bit information of the first information domain may also be used to indicate the first type of terminal to terminate the repeated transmission. The state represented by all or part of the bit information may be a state composed of binary numbers corresponding to all or part of the bits. For example, when there are two bits in total in the first information domain, all the corresponding states are “00”, “01”, “10”, “11”, and the first information domain can correspond to all or part of the states. For another example, when there are three bits in total in the first information domain, the corresponding states are “000”, “010”, “001”, “011”, “100”, “111”, “101”, “110”, and the first information domain may correspond to all or part of the states.

### Example 2

In this example, the network indicates the first type of terminal to terminate the repeated transmission through a second information domain in the DCI.

In the embodiment, all or part of bit information of the second information domain may be used to indicate the first type of terminal to terminate the repeated transmission. There may be one or more bits corresponding to the bit information here, and when there are a plurality of bits, the plurality of bits may or may not be consecutive. When there are one or more bits, it may be any one or more bits in the second information domain. That is, in this example, it is indicated, through the information of the one or more bits in the second information domain, that the first type of terminal is prohibited from the repeated transmission.

In the embodiment, part of states represented by all or part of the bit information of the second information domain may also be used to indicate the first type of terminal to terminate the repeated transmission. The state represented by all or part of the bit information may be a state composed of binary numbers corresponding to all or part of the bits. For example, when there are two bits in total in the second information domain, all the corresponding states are “00”, “01”, “10”, “11”, and the second information domain can correspond to all or part of the states. For another example, when there are three bits in total in the second information domain, the corresponding states are “000”, “010”, “001”, “011”, “100”, “111”, “101”, “110”, and the second information domain may correspond to all or part of the states.

### Example 3

In this example, the network indicates the first type of terminal to terminate the repeated transmission through a third information domain in the DCI.

In the embodiment, all or part of bit information of the third information domain may be used to indicate the first type of terminal to terminate the repeated transmission. There may be one or more bits corresponding to the bit information here, and when there are a plurality of bits, the plurality of bits may or may not be consecutive. When there are one or more bits, it may be any one or more bits in the third information domain. That is, in this example, it is indicated, through the information of the one or more bits in the third information domain, that the first type of terminal is prohibited from the repeated transmission.

In the embodiment, part of states represented by all or part of the bit information of the third information domain may also be used to indicate the first type of terminal to terminate the repeated transmission. The state represented by all or part of the bit information may be a state composed of binary numbers corresponding to all or part of the bits. For example, when there are two bits in total in the third information domain, all the corresponding states are “00”, “01”, “10”, “11”, and the third information domain can correspond to all or part of the states. For another example, when there are three bits in total in the third information domain, the corresponding states are “000”, “010”, “001”, “011”, “100”, “111”, “101”, “110”, and the third information domain may correspond to all or part of the states.

It should be noted that the above-mentioned first information domain to third information domain may be any three different information domains in the DCI. It should be noted that the information domain may be composed of undefined idle bits in the DCI, or may also be obtained by reusing another information domain. When the first information domain to the third information domain are obtained by reusing other information domains, the corresponding first information domain to third information domain can be one of the following.

(1) A Power Control Domain Indicating Power Control of a Second Type of Terminal, which May be a Transmit Power Control (TPC) Information Domain

In some embodiments, the corresponding information domain is used to indicate the power control of the second type of terminal, and the second type of terminal may be a terminal that is different from the first type of terminal in terms of terminal capability or channel state. For example, the first type of terminal is a normal NR terminal, and the second type of terminal is a Redcap terminal. Alternatively, the first type of terminal is a terminal with the poor coverage that needs to use the repeated transmission, and the second type of terminal is a terminal with the good coverage that does not need to use the repeated transmission.

In this example, when the first type of terminal is configured to use the repeated transmission, the TPC information domain in the DCI will no longer be used for the power control in this case, and part of bits or states of the TPC information domain can be used for the indication of the early termination. For example, one bit in the TPC information domain is used for indication, or when information of two bits of the TPC information domain is set to 00, it indicates the early termination.

Note that, in this example, the remaining bit information of the information domain can further be used to perform a corresponding power control function.

For example, when the first information domain is further used to indicate the power control of the second type of terminal, the network may indicate the power control of the first type of terminal by using a remaining bit or a remaining state of the first information domain, in response to the indicating the first type of terminal to terminate the repeated transmission by using the part of the bit information of the first information domain, or indicating the first type of terminal to terminate the repeated transmission by using part of states represented by all or part of the bit information of the first information domain. For example, the remaining bit is a second bit, then when the second bit is 0 or 1, it can be used to indicate the power control of the first type of terminal.

(2) A Modulation and Coding Scheme (MCS) Information Domain for Indicating a Modulation and Coding Scheme of the Second Type of Terminal

In some embodiments, the corresponding information domain is used to indicate the modulation and coding scheme of the second type of terminal, and the second type of terminal may be a terminal that is different from the first type of terminal in terms of terminal capability or channel state. For example, the first type of terminal is a normal NR terminal, and the second type of terminal is a Redcap terminal. Alternatively, the first type of terminal is a terminal with the poor coverage that needs to use the repeated transmission, and the second type of terminal is a terminal with the good coverage that does not need to use the repeated transmission.

In this example, when the first type of terminal is configured to use the repeated transmission, it is almost impossible to use a high-order MCS, such as 64QAM, and in this case, part of states and information of the MCS information domain can be used for the indication of the early termination.

For example, the MCS information domain has five bits in total. When the first type of terminal is configured to use the repeated transmission, then in this case, only four bits are used to indicate the MCS, and the remaining one bit is used to indicate whether to perform the early termination. Alternatively, the MCS information domain has five bits in total, which can represent 32 states in total, then in this case, the first 31 states can be used for the indication of the MCS or other indications, and the last state 11111 is used to indicate the early termination.

Note that, in this example, the remaining bit information of the information domain can further be used to perform a corresponding modulation and coding scheme function.

For example, when the second information domain is further used to indicate the modulation and coding scheme, the network may indicate the modulation and coding scheme of the first type of terminal by using a remaining bit or a remaining state of the second information domain, in response to the indicating the first type of terminal to terminate the repeated transmission by using the part of the bit information of the second information domain, or indicating the first type of terminal to terminate the repeated transmission by using the part of states represented by all or part of the bit information of the second information domain. For example, the remaining bit is a second bit, then when the second bit is 0 or 1, it can be used to indicate the modulation and coding scheme of the first type of terminal.

(3) An Information Domain for Indicating a Hybrid Automatic Repeat Request Process Identity of the Second Type of Terminal, that is, an Information Domain Corresponding to a Hybrid Automatic Repeat reQuest (HARQ) Process ID

In some embodiments, the corresponding information domain is used to indicate the HARQ process ID of the second type of terminal, and the second type of terminal may be a terminal that is different from the first type of terminal in terms of terminal capability or channel state. For example, the first type of terminal is a normal NR terminal, and the second type of terminal is a Redcap terminal. Alternatively, the first type of terminal is a terminal with the poor coverage that needs to use the repeated transmission, and the second type of terminal is a terminal with the good coverage that does not need to use the repeated transmission.

In this example, when the first type of terminal is configured to use the repeated transmission, it is almost impossible to use 16 parallel HARQ transmissions, and then in this case, part of states or bits of the HARQ process ID information domain can be used for the indication of the early termination.

For example, the HARQ process ID information domain has four bits in total. When the terminal is configured to use the repeated transmission, then in this case, only three bits are used to indicate the HARQ process ID, and the remaining one bit is used to indicate whether to perform the early termination. Alternatively, the HARQ process ID information domain has four bits in total, which can represent 16 states in total, then in this case, the first 15 states can be used for the indication of the HARQ process ID or other indications, and the last state 1111 is used to indicate the early termination.

Note that, in this example, the remaining bit information of the information domain can further be used to perform a corresponding HARQ process ID function.

For example, when the third information domain is further used to indicate the HARQ process identity, the network may indicate the HARQ process ID of the first type of terminal by using a remaining bit or a remaining state of the third information domain, in response to the indicating the first type of terminal to terminate the repeated transmission by using the part of the bit information of the third information domain, or indicating the first type of terminal to terminate the repeated transmission by using part of states represented by all or part of the bit information of the third information domain. For example, the remaining bit is a second bit, then when the second bit is 0 or 1, it can be used to indicate the HARQ process ID of the first type of terminal.

To sum up, according to the early termination method of embodiments of the present disclosure, the information domain in the DCI can be determined in different manners according to scenario requirements, which improves the practicability of the early termination.

The following describes the early termination method in embodiments of the present disclosure focusing on a first type of terminal side.

FIG. 3 is a flowchart of an early termination method according to another embodiment of the present disclosure. As shown in FIG. 3, the method includes:

in step 301, a Physical Downlink Control Channel (PDCCH) carrying Downlink Control Information (DCI) is monitored; and

in step 302, a repeated transmission of a first type of terminal is terminated according to indication information of a DCI information domain.

The DCI may be control information related to a physical uplink and downlink shared channel transmitted by a PDCCH, and the DCI includes several related contents such as RB resource allocation information, a Modulation and Coding Scheme (MCS), a HARQ-ID and so on. Only when the terminal correctly decodes the DCI, it can correctly process Physical Downlink Shared Channel (PDSCH) data or Physical Uplink Shared Channel (PUSCH) data.

In the embodiment, the first type of terminal is indicated to terminate the repeated transmission through the information domain in the DCI. Thus, in this example, the PDCCH carrying the DCI is monitored, and then the repeated transmission of the first type of terminal is terminated according to the indication information of the DCI information domain.

To sum up, according to the early termination method of embodiments of the present disclosure, the first type of terminal monitors the PDCCH carrying the DCI, and then terminates the repeated transmission of the first type of terminal according to the indication information of the DCI information domain. Thus, it is realized that the first type of terminal can support the early termination in the coverage enhancement scenario, so that the first type of terminal can save power in the retransmission scenario.

Based on the above-mentioned embodiments, the information domain in the DCI that indicates the first type of terminal to terminate the repeated transmission may correspond to different contents in different scenarios, and the following is illustrative description.

### Example 1

In this example, the information domain in the DCI is a first information domain, and the first information domain indicates the first type of terminal to terminate the repeated transmission.

In the embodiment, all or part of bit information of the first information domain may be used to indicate the first type of terminal to terminate the repeated transmission. There may be one or more bits corresponding to the bit information here, and when there is a plurality of bits, the plurality of bits may or may not be consecutive. When there are one or more bits, it may be any one or more bits in the first information domain. That is, in this example, it is indicated, through the information of the one or more bits in the first information domain, that the first type of terminal is prohibited from the repeated transmission.

In the embodiment, part of states represented by all or part of the bit information of the first information domain may also be used to indicate the first type of terminal to terminate the repeated transmission. The state represented by all or part of the bit information may be a state composed of binary numbers corresponding to all or part of the bits. For example, when there are two bits in total in the first information domain, all the corresponding states are “00”, “01”, “10”, “11”, and the first information domain can correspond to all or part of the states. For another example, when there are three bits in total in the first information domain, the corresponding states are “000”, “010”, “001”, “011”, “100”, “111”, “101”, “110”, and the first information domain may correspond to all or part of the states.

### Example 2

In this example, the information domain in the DCI is a second information domain, and the second information domain indicates the first type of terminal to terminate the repeated transmission.

In the embodiment, all or part of bit information of the second information domain may be used to indicate the first type of terminal to terminate the repeated transmission. There may be one or more bits corresponding to the bit information here, and when there are a plurality of bits, the plurality of bits may or may not be consecutive. When there are one or more bits, it may be any one or more bits in the second information domain. That is, in this example, it is indicated, through the information of the one or more bits in the second information domain, that the first type of terminal is prohibited from the repeated transmission.

In the embodiment, part of states represented by all or part of the bit information of the second information domain may also be used to indicate the first type of terminal to terminate the repeated transmission. The state represented by all or part of the bit information may be a state composed of binary numbers corresponding to all or part of the bits. For example, when there are two bits in total in the second information domain, all the corresponding states are “00”, “01”, “10”, “11”, and the second information domain can correspond to all or part of the states. For another example, when there are three bits in total in the second information domain, the corresponding states are “000”, “010”, “001”, “011”, “100”, “111”, “101”, “110”, and the second information domain may correspond to all or part of the states.

### Example 3

In this example, the information domain in the DCI is a third information domain, and the third information domain indicates the first type of terminal to terminate the repeated transmission.

In the embodiment, all or part of bit information of the third information domain may be used to indicate the first type of terminal to terminate the repeated transmission. There may be one or more bits corresponding to the bit information here, and when there are a plurality of bits, the plurality of bits may or may not be consecutive. When there are one or more bits, it may be any one or more bits in the third information domain. That is, in this example, it is indicated, through the information of the one or more bits in the third information domain, that the first type of terminal is prohibited from the repeated transmission.

In the embodiment, part of states represented by all or part of the bit information of the third information domain may also be used to indicate the first type of terminal to terminate the repeated transmission. The state represented by all or part of the bit information may be a state composed of binary numbers corresponding to all or part of the bits. For example, when there are two bits in total in the third information domain, all the corresponding states are “00”, “01”, “10”, “11”, and the third information domain can correspond to all or part of the states. For another example, when there are three bits in total in the third information domain, the corresponding states are “000”, “010”, “001”, “011”, “100”, “111”, “101”, “110”, and the third information domain may correspond to all or part of the states.

It should be noted that the above-mentioned first information domain to third information domain may be any three different information domains in the DCI. It should be noted that the information domain may be composed of undefined idle bits in the DCI, or may also be obtained by reusing another information domain. When the first information domain to the third information domain are obtained by reusing other information domains, the corresponding first information domain to third information domain can be one of the following.

(1) A Power Control Domain Indicating Power Control of a Second Type of Terminal, which May be a Transmit Power Control (TPC) Information Domain

In some embodiments, the corresponding information domain is used to indicate the power control of the second type of terminal, and the second type of terminal may be a terminal that is different from the first type of terminal in terms of terminal capability or channel state. For example, the first type of terminal is a normal NR terminal, and the second type of terminal is a Redcap terminal. Alternatively, the first type of terminal is a terminal with the poor coverage that needs to use the repeated transmission, and the second type of terminal is a terminal with the good coverage that does not need to use the repeated transmission.

In this example, when the first type of terminal is configured to use the repeated transmission, the TPC information domain in the DCI will no longer be used for the power control in this case, and part of bits or states of the TPC information domain can be used for the indication of the early termination. For example, one bit in the TPC information domain is used for indication, or when information of two bits of the TPC information domain is set to 00, it indicates the early termination.

Note that, in this example, the remaining bit information of the information domain can further be used to perform a corresponding power control function.

For example, when the first information domain is further used to indicate the power control of the second type of terminal, the network may indicate the power control of the first type of terminal by using a remaining bit or a remaining state of the first information domain, in response to the indicating the first type of terminal to terminate the repeated transmission by using the part of the bit information of the first information domain, or indicating the first type of terminal to terminate the repeated transmission by using part of states represented by all or part of the bit information of the first information domain. For example, the remaining bit is a second bit, then when the second bit is 0 or 1, it can be used to indicate the power control of the first type of terminal.

(2) A Modulation and Coding Scheme (MCS) Information Domain for Indicating a Modulation and Coding Scheme of the Second Type of Terminal

In some embodiments, the corresponding information domain is used to indicate the modulation and coding scheme of the second type of terminal, and the second type of terminal may be a terminal that is different from the first type of terminal in terms of terminal capability or channel state. For example, the first type of terminal is a normal NR terminal, and the second type of terminal is a Redcap terminal. Alternatively, the first type of terminal is a terminal with the poor coverage that needs to use the repeated transmission, and the second type of terminal is a terminal with the good coverage that does not need to use the repeated transmission.

In this example, when the first type of terminal is configured to use the repeated transmission, it is almost impossible to use a high-order MCS, such as 64QAM, and in this case, part of states and information of the MCS information domain can be used for the indication of the early termination.

For example, the MCS information domain has five bits in total. When the first type of terminal is configured to use the repeated transmission, then in this case, only four bits are used to indicate the MCS, and the remaining one bit is used to indicate whether to perform the early termination. Alternatively, the MCS information domain has five bits in total, which can represent 32 states in total, then in this case, the first 31 states can be used for the indication of the MCS or other indications, and the last state 11111 is used to indicate the early termination.

Note that, in this example, the remaining bit information of the information domain can further be used to perform a corresponding modulation and coding scheme function.

For example, when the second information domain is further used to indicate the modulation and coding scheme, the network may indicate the modulation and coding scheme of the first type of terminal by using a remaining bit or a remaining state of the second information domain, in response to the indicating the first type of terminal to terminate the repeated transmission by using the part of the bit information of the second information domain, or indicating the first type of terminal to terminate the repeated transmission by using the part of states represented by all or part of the bit information of the second information domain. For example, the remaining bit is a second bit, then when the second bit is 0 or 1, it can be used to indicate the modulation and coding scheme of the first type of terminal.

(3) An Information Domain for Indicating a Hybrid Automatic Repeat Request Process Identity of the Second Type of Terminal, that is, an Information Domain Corresponding to a Hybrid Automatic Repeat reQuest (HARQ) Process ID

In some embodiments, the corresponding information domain is used to indicate the HARQ process ID of the second type of terminal, and the second type of terminal may be a terminal that is different from the first type of terminal in terms of terminal capability or channel state. For example, the first type of terminal is a normal NR terminal, and the second type of terminal is a Redcap terminal. Alternatively, the first type of terminal is a terminal with the poor coverage that needs to use the repeated transmission, and the second type of terminal is a terminal with the good coverage that does not need to use the repeated transmission.

In this example, when the first type of terminal is configured to use the repeated transmission, it is almost impossible to use 16 parallel HARQ transmissions, and then in this case, part of states or bits of the HARQ process ID information domain can be used for the indication of the early termination.

For example, the HARQ process ID information domain has four bits in total. When the terminal is configured to use the repeated transmission, then in this case, only three bits are used to indicate the HARQ process ID, and the remaining one bit is used to indicate whether to perform the early termination. Alternatively, the HARQ process ID has four bits in total, which can represent 16 states in total, then in this case, the first 15 states can be used for the indication of the HARQ process ID or other indications, and the last state 1111 is used to indicate the early termination.

Note that, in this example, the remaining bit information of the information domain can further be used to perform a corresponding HARQ process ID function.

For example, when the third information domain is further used to indicate the HARQ process identity, the network may indicate the HARQ process ID of the first type of terminal by using a remaining bit or a remaining state of the third information domain, in response to the indicating the first type of terminal to terminate the repeated transmission by using the part of the bit information of the third information domain, or indicating the first type of terminal to terminate the repeated transmission by using part of states represented by all or part of the bit information of the third information domain. For example, the remaining bit is a second bit, then when the second bit is 0 or 1, it can be used to indicate the HARQ process ID of the first type of terminal.

To sum up, according to the early termination method of embodiments of the present disclosure, the information domain in the DCI can be determined in different manners according to scenario requirements, which improves the practicability of the early termination.

Corresponding to the early termination method provided by the above several embodiments, the present disclosure further provides an early termination apparatus. Since the early termination apparatus provided by embodiments of the present disclosure corresponds to the early termination method provided by the above several embodiments, the implementations of the early termination method are also applicable to the early termination apparatus provided in the embodiment, which will not be described in detail in the embodiment.

FIG. 4 is a schematic structural diagram of an early termination apparatus provided according to the present disclosure. The early termination apparatus is applied on a network, and as shown in FIG. 4, the early termination apparatus includes an indication module 301.

The indication module 401 is configured to indicate a first type of terminal to terminate a repeated transmission through an information domain in Downlink Control Information (DCI).

To sum up, according to the early termination apparatus of embodiments of the present disclosure, the network indicates the first type of terminal to terminate the repeated transmission through the information domain in the DCI, thereby realizing that the first type of terminal can support the early termination in the coverage enhancement scenario, so that the first type of terminal can save power in the retransmission scenario.

Corresponding to the early termination method provided by the above several embodiments, the present disclosure further provides an early termination apparatus. Since the early termination apparatus provided by embodiments of the present disclosure corresponds to the early termination method provided by the above several embodiments, the implementations of the early termination method are also applicable to the early termination apparatus provided in the embodiment, which will not be described in detail in the embodiment.

FIG. 5 is a schematic structural diagram of an early termination apparatus provided according to the present disclosure. The early termination apparatus is applied on a first type of terminal, and as shown in FIG. 5, the early termination apparatus includes a monitoring module 501 and a termination module 502.

The monitoring module 501 is configured to monitor a PDCCH carrying Downlink Control Information (DCI).

The termination module 502 is configured to terminate a repeated transmission of the first type of terminal according to indication information of a DCI information domain.

To sum up, according to the early termination apparatus of embodiments of the present disclosure, the PDCCH carrying the DCI is monitored, and the repeated transmission of the first type of terminal is terminated according to the indication information of the DCI information domain, thereby realizing that the first type of terminal can support the early termination in the coverage enhancement scenario, so that the first type of terminal can save power in the retransmission scenario.

According to embodiments of the present disclosure, the present disclosure further provides a communication device and a readable storage medium.

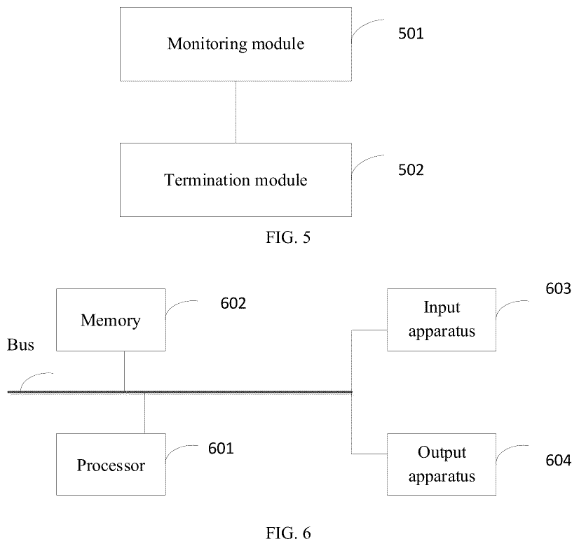

As shown in FIG. 6, which is a block diagram of a communication device for an early termination method according to an embodiment of the present disclosure, the communication device is intended to represent various forms of digital computers, such as a laptop, a desktop, a workstation, a personal digital assistant, a server, a blade server, a mainframe computer, and other suitable computers. The communication device may also represent various forms of mobile devices, such as a personal digital processor, a cellular phone, a smart phone, a wearable device, and other similar computing devices. The components shown herein, their connections and relationships, and their functions are described as examples only, and are not intended to limit implementations of the early termination method of the present disclosure described and/or claimed herein.

As shown in FIG. 6, the communication device may include: one or more processors 601, a memory 602, and interfaces configured to connect the respective components, including high-speed interfaces and low-speed interfaces. The respective components are interconnected using different buses and may be mounted at a common motherboard or in other manners as desired. The processor may process instructions for execution within the communication device, including instructions stored in or at the memory to display graphical information for a GUI at an external input/output apparatus, such as a display device coupled to the interface. In other implementations, a plurality of processors and/or a plurality of buses may be used with a plurality of memories, if desired. Likewise, a plurality of communication devices may be connected, with each device providing some of necessary operations (e.g., as a server array, a set of blade servers, or a multi-processor system). In FIG. 6, one processor 601 is taken as an example.

The memory 602 is configured as the non-transitory computer readable storage medium provided by the present disclosure. The memory stores instructions executable by the at least one processor to cause the at least one processor to perform the early termination method provided by the present disclosure. The non-transitory computer readable storage medium according to the present disclosure stores computer instructions for causing a computer to perform the early termination method provided by the present disclosure.

The memory 602 which is a non-transitory computer readable storage medium may be configured to store non-transitory software programs, non-transitory computer executable programs and modules, such as program instructions/modules corresponding to the early termination method in embodiments of the present disclosure. The processor 601 executes various functional applications and data processing of a server, that is, implements the early termination method in the above-mentioned method embodiments, by running the non-transitory software programs, instructions, and modules stored in the memory 602.

The memory 602 may include a program storage area and a data storage area, the program storage area may store an operating system and an application program required for at least one function, and the data storage area may store data created according to use of the communication device for positioning, or the like. Furthermore, the memory 602 may include a high-speed random access memory, or a non-transitory memory, such as at least one magnetic disk storage device, a flash memory device, or other non-transitory solid state storage devices. In some embodiments, the memory 602 may include memories remote from the processor 601, and such remote memories may be connected to the communication device for positioning via a network. Examples of such a network include, but are not limited to, the Internet, intranets, local area networks, mobile communication networks, and combinations thereof.

The communication device for executing the early termination method may further include an input apparatus 603 and an output apparatus 604. The processor 601, the memory 602, the input apparatus 603 and the output apparatus 604 may be connected by a bus or other means, and FIG. 6 takes the connection by a bus as an example.

The input apparatus 603 may receive input numeric or character information and generate key signal input related to user settings and function control of the communication device for positioning, such as a touch screen, a keypad, a mouse, a track pad, a touch pad, a pointing stick, one or more mouse buttons, a trackball, a joystick and other input apparatuses. The output apparatus 604 may include a display device, an auxiliary lighting apparatus (for example, an LED) and a tactile feedback apparatus (for example, a vibrating motor), or the like. The display device may include, but is not limited to, a liquid crystal display (LCD), a light emitting diode (LED) display, and a plasma display. In some implementations, the display device may be a touch screen.

Various implementations of the systems and technologies described here may be implemented in digital electronic circuitry, integrated circuitry, ASICs (application specific integrated circuits), computer hardware, firmware, software, and/or combinations thereof. These various implementations may be implemented in one or more computer programs which are executable and/or interpretable on a programmable system including at least one programmable processor, and the programmable processor may be special or general, and may receive data and instructions from, and transmitting data and instructions to, a storage system, at least one input apparatus, and at least one output apparatus.

These computer programs (also known as programs, software, software applications, or codes) include machine instructions for a programmable processor, and may be implemented using high-level procedural and/or object-oriented programming languages, and/or assembly/machine languages. As used herein, the terms “machine readable medium” and “computer readable medium” refer to any computer program product, device and/or apparatus (for example, magnetic discs, optical disks, memories, programmable logic devices (PLDs)) for providing machine instructions and/or data to a programmable processor, including a machine readable medium which receives machine instructions as a machine readable signal. The term “machine readable signal” refers to any signal for providing machine instructions and/or data to a programmable processor.

To provide interaction with a user, the systems and technologies described here may be implemented on a computer having: a display apparatus (for example, a Cathode Ray Tube (CRT) or Liquid Crystal Display (LCD) monitor) for displaying information to the user; and a keyboard and a pointing apparatus (for example, a mouse or a trackball) by which the user may provide an input to the computer. Other kinds of apparatuses may also be used to provide interaction with the user; for example, feedback provided to a user may be any form of sensory feedback (for example, visual feedback, auditory feedback, or tactile feedback); and the input from the user may be received in any form (including acoustic, voice or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a Local Area Network (LAN), a Wide Area Network (WAN) and the Internet.

A computer system may include a client and a server. Generally, the client and the server are remote from each other and interact through the communication network. The relationship between the client and the server is generated by virtue of computer programs which are run on respective computers and have a client-server relationship to each other.

The network indicates the first type of terminal to terminate the repeated transmission through the information domain in the DCI, thereby realizing that the first type of terminal can support the early termination in the coverage enhancement scenario, so that the first type of terminal can save power in the retransmission scenario.

In a first aspect, embodiments of the present disclosure propose an early termination method, which is applied to a network, and the early termination method includes: instructing, through an information domain in Downlink Control Information (DCI), a first type of terminal to terminate a repeated transmission.

In some embodiments of the present disclosure, the indicating, through the information domain in the DCI, the first type of terminal to terminate the repeated transmission includes: indicating, through a first information domain in the DCI, the first type of terminal to terminate the repeated transmission.

In some embodiments of the present disclosure, the indicating, through the first information domain in the DCI, the first type of terminal to terminate the repeated transmission includes: indicating, by using all or part of bit information of the first information domain, the first type of terminal to terminate the repeated transmission, or indicating, by using part of states represented by all or part of the bit information of the first information domain, the first type of terminal to terminate the repeated transmission.

In some embodiments of the present disclosure, the first information domain is further used to indicate power control of a second type of terminal, and the second type of terminal is different from the first type of terminal in terms of terminal capability or channel state.

In some embodiments of the present disclosure, power control of the first type of terminal is indicated by using a remaining bit or a remaining state of the first information domain, in response to the indicating, by using the part of the bit information of the first information domain, the first type of terminal to terminate the repeated transmission, or indicating, by using the part of the states represented by all or part of the bit information of the first information domain, the first type of terminal to terminate the repeated transmission.

In some embodiments of the present disclosure, the indicating, through the information domain in the DCI, the first type of terminal to terminate the repeated transmission includes: indicating, through a second information domain in the DCI, the first type of terminal to terminate the repeated transmission.

In some embodiments of the present disclosure, the indicating, through the second information domain in the DCI, the first type of terminal to terminate the repeated transmission includes: indicating, by using all or part of bit information of the second information domain, the first type of terminal to terminate the repeated transmission, or indicating, by using part of states represented by all or part of the bit information of the second information domain, the first type of terminal to terminate the repeated transmission.

In some embodiments of the present disclosure, the second information domain is further used to indicate a modulation and coding scheme of a second type of terminal, and the second type of terminal is different from the first type of terminal in terms of terminal capability or channel state.

In some embodiments of the present disclosure, a modulation and coding scheme of the first type of terminal is indicated by using a remaining bit or a remaining state of the second information domain, in response to the indicating, by using the part of the bit information of the second information domain, the first type of terminal to terminate the repeated transmission, or indicating, by using the part of the states represented by all or part of the bit information of the second information domain, the first type of terminal to terminate the repeated transmission.

In some embodiments of the present disclosure, the indicating, through the information domain in the DCI, the first type of terminal to terminate the repeated transmission includes: indicating, through a third information domain in the DCI, the first type of terminal to terminate the repeated transmission.

In some embodiments of the present disclosure, the indicating, through the third information domain in the DCI, the first type of terminal to terminate the repeated transmission includes: indicating, by using all or part of bit information of the third information domain, the first type of terminal to terminate the repeated transmission, or indicating, by using part of states represented by all or part of the bit information of the third information domain, the first type of terminal to terminate the repeated transmission.

In some embodiments of the present disclosure, the third information domain is further used to indicate a hybrid automatic repeat request process identity of a second type of terminal, and the second type of terminal is different from the first type of terminal in terms of terminal capability or channel state.

In some embodiments of the present disclosure, a modulation and coding scheme of the first type of terminal is indicated by using a remaining bit or a remaining state of the second information domain, in response to the indicating, by using the part of the bit information of the second information domain, the first type of terminal to terminate the repeated transmission, or indicating, by using the part of the states represented by all or part of the bit information of the second information domain, the first type of terminal to terminate the repeated transmission.

In a second aspect, embodiments of the present disclosure propose an early termination method, which is applied to a first type of terminal, and the early termination method includes: monitoring a Physical Downlink Control Channel (PDCCH) carrying Downlink Control Information (DCI); and terminating a repeated transmission of the first type of terminal according to indication information of a DCI information domain.

In some embodiments of the present disclosure, the terminating the repeated transmission of the first type of terminal according to the indication information of the DCI information domain includes: terminating the repeated transmission of the first type of terminal according to the indication information of a first information domain in the DCI.

In some embodiments of the present disclosure, the indication information of the first information domain in the DCI includes: all or part of bit information of the first information domain indicates the first type of terminal to terminate the repeated transmission, or part of states represented by all or part of the bit information of the first information domain indicates the first type of terminal to terminate the repeated transmission.

In some embodiments of the present disclosure, the method further includes: responding to indicating the first type of terminal to terminate the repeated transmission by using the part of the bit information of the first information domain or indicating the first type of terminal to terminate the repeated transmission by using the part of the states represented by all or part of the bit information of the first information domain, responding to indicating power control of the first type of terminal by using a remaining bit or a remaining state of the first information domain.

In some embodiments of the present disclosure, the terminating the repeated transmission of the first type of terminal according to the indication information of the DCI information domain includes: terminating the repeated transmission of the first type of terminal according to the indication information of a second information domain in the DCI.

In some embodiments of the present disclosure, the indication information of the second information domain in the DCI includes:
all or part of bit information of the second information domain indicates the first type of terminal to terminate the repeated transmission, or,
part of states represented by all or part of the bit information of the second information domain indicates the first type of terminal to terminate the repeated transmission.

In some embodiments of the present disclosure, the method further includes: responding to indicating the first type of terminal to terminate the repeated transmission by using the part of the bit information of the second information domain or indicating the first type of terminal to terminate the repeated transmission by using the part of the states represented by all or part of the bit information of the second information domain, and responding to indicating a modulation and coding scheme of the first type of terminal by using a remaining bit or a remaining state of the second information domain.

In some embodiments of the present disclosure, the terminating the repeated transmission of the first type of terminal according to the indication information of the DCI information domain includes: terminating the repeated transmission of the first type of terminal according to the indication information of a third information domain in the DCI.

In some embodiments of the present disclosure, the indication information of the third information domain in the DCI includes: all or part of bit information of the third information domain indicates the first type of terminal to terminate the repeated transmission, or

part of states represented by all or part of the bit information of the third information domain indicates the first type of terminal to terminate the repeated transmission.

In some embodiments of the present disclosure, the method further includes: responding to indicating the first type of terminal to terminate the repeated transmission by using the part of the bit information of the third information domain or indicating the first type of terminal to terminate the repeated transmission by using the part of the states represented by all or part of the bit information of the third information domain, and responding to indicating a hybrid automatic repeat request process identity of the first type of terminal by using a remaining bit or a remaining state of the third information domain.

In a third aspect, embodiments of the present disclosure propose an early termination apparatus, which is applied to a network, and the early termination apparatus includes an indication module, configured to indicate, through an information domain in Downlink Control Information (DCI), a first type of terminal to terminate a repeated transmission.

In a fourth aspect, embodiments of the present disclosure propose an early termination apparatus, which is applied to a first type of terminal, and the early termination apparatus includes a monitoring module, configured to monitor a Physical Downlink Control Channel (PDCCH) carrying Downlink Control Information (DCI); and a termination module, configured to terminate a repeated transmission of the first type of terminal according to indication information of a DCI information domain.

In a fifth aspect, embodiments of the present disclosure propose a communication device, including a processor, a transceiver, a memory, and a computer program stored on the memory, wherein the processor implements the early termination method proposed in embodiments of the first aspect or the second aspect by running the computer program to.

In a sixth aspect, embodiments of the present disclosure propose a processor-readable storage medium having a computer program stored thereon, wherein the computer program is configured to cause a processor to execute the early termination method proposed in embodiments of the first aspect or the second aspect.

The early termination method and apparatus, the communication device and the storage medium proposed by the present disclosure have at least the following technical effects:

a redundant bit or redundant information when the terminal performs an overlay transmission is reused to indicate the early termination of the terminal, achieving the power saving of the first type of terminal in a retransmission scenario.

It should be understood that various forms of the flows shown above may be used and reordered, and steps may be added or deleted. For example, individual steps described in the present disclosure may be executed in parallel, sequentially, or in different orders, and are not limited herein as long as the desired results of the technical solution disclosed in the present disclosure may be achieved.

The above-mentioned specific embodiments do not limit the protection scope of the present disclosure. It should be understood by those skilled in the art that various modifications, combinations, sub-combinations and replacements may be made depending on design requirements and other factors. Any modifications, equivalent replacements, and improvements made within the spirit and principles of the present disclosure should be included within the protection scope of the present disclosure.

1. An early termination method, performed by a network, and comprising:
indicating, through an information domain in Downlink Control Information (DCI), a first type of terminal to terminate a repeated transmission.

2. The method according to claim 1, wherein indicating, through the information domain in the DCI, the first type of terminal to terminate the repeated transmission comprises:
indicating, through a first information domain in the DCI, the first type of terminal to terminate the repeated transmission,
wherein indicating, through the first information domain in the DCI, the first type of terminal to terminate the repeated transmission comprises:
indicating, by using all or part of bit information of the first information domain, the first type of terminal to terminate the repeated transmission, or
indicating, by using part of states represented by all or part of bit information of the first information domain, the first type of terminal to terminate the repeated transmission.

3. (canceled)

4. The method according to claim 2, wherein the first information domain is further used to indicate power control of a second type of terminal, and the second type of terminal is different from the first type of terminal in terms of terminal capability or channel state.

5. The method according to claim 2, further comprising: in response to indicating, by using the part of the bit information of the first information domain, the first type of terminal to terminate the repeated transmission, using a remaining bit of the first information domain to indicate power control of the first type of terminal; or
in response to indicating, by using the part of the states represented by all or part of the bit information of the first information domain, the first type of terminal to terminate the repeated transmission, using a remaining state of the first information domain to indicate power control of the first type of terminal.

6. The method according to claim 1, wherein indicating, through the information domain in the DCI, the first type of terminal to terminate the repeated transmission comprises:
indicating, through a second information domain in the DCI, the first type of terminal to terminate the repeated transmission,
wherein indicating, through the second information domain in the DCI, the first type of terminal to terminate the repeated transmission comprises:
indicating, by using all or part of bit information of the second information domain, the first type of terminal to terminate the repeated transmission, or
indicating, by using part of states represented by all or part of bit information of the second information domain, the first type of terminal to terminate the repeated transmission.

7. (canceled)

8. The method according to claim 6, wherein the second information domain is further used to indicate a modulation and coding scheme of a second type of terminal, and the second type of terminal is different from the first type of terminal in terms of terminal capability or channel state.

9. The method according to claim 6, further comprising:
in response to indicating, by using the part of the bit information of the second information domain, the first type of terminal to terminate the repeated transmission, using a remaining bit of the second information domain to indicate a modulation and coding scheme of the first type of terminal; or
in response to indicating, by using the part of the states represented by all or part of the bit information of the second information domain, the first type of terminal to terminate the repeated transmission, using a remaining state of the second information domain to indicate a modulation and coding scheme of the first type of terminal.

10. The method according to claim 1, wherein indicating, through the information domain in the DCI, the first type of terminal to terminate the repeated transmission comprises:
indicating, through a third information domain in the DCI, the first type of terminal to terminate the repeated transmission,
wherein indicating, through the third information domain in the DCI, the first type of terminal to terminate the repeated transmission comprises:
indicating, by using all or part of bit information of the third information domain, the first type of terminal to terminate the repeated transmission, or
indicating, by using part of states represented by all or part of bit information of the third information domain, the first type of terminal to terminate the repeated transmission.

11. (canceled)

12. The method according to claim 10, wherein the third information domain is further used to indicate a hybrid automatic repeat request process identity of a second type of terminal, and the second type of terminal is different from the first type of terminal in terms of terminal capability or channel state.

13. The method according to claim 10, further comprising:
in response to indicating, by using the part of the bit information of the third information domain, the first type of terminal to terminate the repeated transmission, using a remaining bit of the third information domain to indicate a hybrid automatic repeat request process identity of the first type of terminal; or
in response to indicating, by using the part of the states represented by all or part of the bit information of the third information domain, the first type of terminal to terminate the repeated transmission, using a remaining state of the third information domain to indicate a hybrid automatic repeat request process identity of the first type of terminal.

14. An early termination method, performed by a first type of terminal, and comprising:
monitoring a Physical Downlink Control Channel (PDCCH) carrying Downlink Control Information (DCI); and
terminating a repeated transmission of the first type of terminal according to indication information of a DCI information domain.

15. The method according to claim 14, wherein terminating the repeated transmission of the first type of terminal according to the indication information of the DCI information domain comprises:
terminating the repeated transmission of the first type of terminal according to the indication information of a first information domain in the DCI,
wherein the indication information of the first information domain in the DCI comprises:
all or part of bit information of the first information domain indicating the first type of terminal to terminate the repeated transmission, or
part of states represented by all or part of bit information of the first information domain indicating the first type of terminal to terminate the repeated transmission.

16. (canceled)

17. The method according to claim 15, further comprising:
in response to determining that the indication information comprises part of the bit information of the first information domain indicating the first type of terminal to terminate the repeated transmission, conducting power control of the first type of terminal device according to a remaining bit of the first information domain; or
in response to determining that the indication information comprises part of states represented by all or part of bit information of the first information domain indicating the first type of terminal to terminate the repeated transmission, conducting power control of the first type of terminal device according to a remaining state of the first information domain.

18. The method according to claim 14, wherein terminating the repeated transmission of the first type of terminal according to the indication information of the DCI information domain comprises:
terminating the repeated transmission of the first type of terminal according to the indication information of a second information domain in the DCI,
wherein the indication information of the second information domain in the DCI comprises:
all or part of bit information of the second information domain indicating the first type of terminal to terminate the repeated transmission, or,
part of states represented by all or part of bit information of the second information domain indicating the first type of terminal to terminate the repeated transmission.

19. (canceled)

20. The method according to claim 198, further comprising:
in response to determining that the indication information comprises part of the bit information of the second information domain indicating the first type of terminal to terminate the repeated transmission, conducting modulation and coding according to a remaining state of the first information domain, which indicates a modulation and coding scheme of the first type of terminal; or
in response to determining that the indication information comprises part of states represented by all or part of bit information of the second information domain indicating the first type of terminal to terminate the repeated transmission, conducting modulation and coding according to a remaining state of the first information domain, which indicates a modulation and coding scheme of the first type of terminal.

21. The method according to claim 14, wherein terminating the repeated transmission of the first type of terminal according to the indication information of the DCI information domain comprises:
terminating the repeated transmission of the first type of terminal according to the indication information of a third information domain in the DCI,
wherein the indication information of the third information domain in the DCI comprises:
all or part of bit information of the third information domain indicating the first type of terminal to terminate the repeated transmission, or
part of states represented by all or part of the bit information of the third information domain indicating the first type of terminal to terminate the repeated transmission.

22. (canceled)

23. The method according to claim 21, further comprising:
in response to determining that the indication information comprises part of the bit information of the third information domain indicating the first type of terminal to terminate the repeated transmission, processing a hybrid automatic repeat request according to a remaining bit of the first information domain, which indicates a hybrid automatic repeat request process identity of the first type of terminal device; or
in response to determining that the indication information comprises part of states represented by all or part of bit information of the third information domain indicating the first type of terminal to terminate the repeated transmission, processing a hybrid automatic repeat request according to a remaining bit of the first information domain, which indicates a hybrid automatic repeat request process identity of the first type of terminal device.

24-25. (canceled)

26. A network, comprising a processor, a transceiver, a memory, and a computer program stored on the memory, wherein the processor is configured to: indicate, through an information domain in Downlink Control Information (DCI), a first type of terminal to terminate a repeated transmission.

27. (canceled)

28. A first type of terminal, comprising a processor, a transceiver, a memory, and a computer program stored on the memory, wherein the processor is configured to implement the early termination method according to claim 14.
